(19) United States
(12) Patent Application Publication
(10) Pub. No.: US 2026/0285214 A1
(43) Pub. Date: Sep. 24, 2026

(54) Floor Support

(71) Applicant: Nissan North America, Inc., Franklin, TN (US)

(72) Inventors: Jason Lyman, Whitmore Lake, MI (US); Sami Dukovic, Sterling Heights, MI (US); Caleb Yacks, Ann Arbor, MI (US)

(21) Appl. No.: 19/083,876

(22) Filed: Mar. 19, 2025

(51) Int. Cl. B60N 3/06

(52) U.S. Cl. CPC B60N 3/06

(57) ABSTRACT

A floor support for a vehicle may include a panel configured to bear weight and to cover a portion of a floor structure of the vehicle. The panel may include an upper surface and a lower surface opposite the upper surface. The floor support may include a standoff disposed on the lower surface of the panel. The standoff may be configured to space a portion of the lower surface of the panel from the portion of the floor structure. The standoff may include legs extending away from the lower surface of the panel. The legs may be configured to bend to control movement of the panel relative to the portion of the floor structure in response to a force applied to the panel.

### TECHNICAL FIELD

The present disclosure relates generally to support structures for vehicles and, more specifically, to support structures for covering portions of a vehicle body.

### BACKGROUND

A vehicle, such as a passenger vehicle, may include a vehicle body that defines a passenger compartment of the vehicle. The vehicle body may include a floor structure that is configured to bear weight, such as the weight of one or more passengers within the passenger compartment. A floor structure is sometimes covered by a support structure, such as a floor support. A passenger may enter and exit the passenger compartment through an opening (e.g., a door), during which the passenger may exert his/her weight upon the floor support. The floor support is sometimes moveable relative to the floor structure.

### SUMMARY

One aspect of the present disclosure is a floor support for a vehicle. The floor support may include a panel configured to bear weight and to cover a portion of a floor structure of the vehicle. The panel may include an upper surface and a lower surface that is opposite the upper surface. The floor support may also include a standoff disposed on the lower surface of the panel. The standoff may be configured to space a portion of the lower surface of the panel from the portion of the floor structure. The standoff may include legs that extend away from the lower surface of the panel. The legs may be configured to bend to control movement of the panel relative to the portion of the floor structure in response to a force applied to the panel.

Another aspect of the present disclosure is a trim panel that is configured to cover a portion of a vehicle body inside a passenger compartment of a vehicle. The trim panel may include an interior surface configured to face the passenger compartment of the vehicle. The trim panel may also include an exterior surface that is opposite the interior surface and that is configured to face the portion of the vehicle body. The trim panel may also include standoffs that are spaced along the exterior surface. Each of the standoffs may include discrete supports that extend from the exterior surface and may be configured to contact the portion of the vehicle body. The discrete supports may be configured to deform to resist movement of the trim panel relative to the portion of the vehicle body.

Another aspect of the present disclosure is a vehicle. The vehicle may include a portion of a vehicle body that has a geometry. The vehicle may also include a panel that covers the portion of the vehicle body. At least a portion of the panel may have a panel geometry that substantially matches the geometry of the portion of the vehicle body. The vehicle may also include standoffs that are spaced on a rear surface of the panel and that may define a gap between the rear surface of the panel and the portion of the vehicle body. The standoffs may be configured to deform in response to a force applied to the panel to move the panel relative to the vehicle body while maintaining the gap defined by the one or more standoffs.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a top view schematic illustration of a vehicle including a vehicle body and a passenger compartment, the vehicle body including a floor structure.

FIG. 2A is an upper perspective view illustration of an example of a front driver-side portion of the floor structure of FIG. 1 within a front driver-side sub-compartment of the passenger compartment.

FIG. 2B is an upper perspective view illustration of an example of a floor support covering the front driver-side portion of the floor structure of FIG. 2A.

FIG. 3A is an upper perspective view illustration of the floor support of FIG. 2B.

FIG. 3B is a lower perspective view illustration of the floor support of FIG. 2B.

FIG. 4 is a lower perspective view illustration of the floor support of FIG. 2B including standoffs according to an example.

FIGS. 5A-5B are side view illustrations of an example of one of the standoffs of a floor support interacting with a portion of a vehicle body according to an example.

FIGS. 6A-6C are bottom view illustrations of another example of one of the standoffs including legs having cross-sectional geometries according to some examples.

FIGS. 7A-7C are bottom view illustrations of another example of one of the standoffs including legs having cross-sectional geometries according to some other examples.

FIGS. 8A-8C are side cross-sectional view illustrations of another example of one of the standoffs including legs having side profiles according to some examples.

FIGS. 9A-9B are bottom view illustrations of another example of a floor support having standoffs disposed at locations on a lower surface of the floor support according to some examples.

FIG. 10 is a top view illustration of another example of a vehicle including a vehicle body and a passenger compartment, the vehicle body including a floor structure that is covered by the floor support of FIG. 2B and some other examples of a floor support.

FIG. 11 is a bottom view illustration of one of the other examples of the floor support of FIG. 10 having standoffs according to an example.

FIGS. 12A-12B are bottom view illustrations of two of the other examples of the floor support of FIG. 10 having standoffs according to some examples.

FIGS. 13A-13B are bottom view illustrations of two of the other examples of the floor support of FIG. 10 having standoffs according to some examples.

FIGS. 14A-14B are bottom view illustrations of two of the other examples of the floor support of FIG. 10 having standoffs according to some examples.

### DETAILED DESCRIPTION

The disclosure herein relates to a support structure that is configured to cover a portion of a vehicle body. Some vehicles, such as passenger vehicles, may include a vehicle body that defines a passenger compartment inside which one or more passengers may be situated (e.g., while traveling in the vehicle). Some vehicle bodies may include a floor structure that is configured to support (e.g., bear) the weight of the one or more passengers in the passenger compartment. Floor structures may include structural components that are irregular and/or unsightly and, therefore, are sometimes covered by a support structure that, for example, obscures (e.g., occludes) certain portions of the floor structure from within the passenger compartment and/or provides a uniform (e.g., regular) surface on which the one or more passengers may be supported. Such a support structure may be referred to herein as a floor support.

When a force is applied to a floor support, such as when a passenger exerts his/her weight upon the floor support, the floor support may move (e.g., shift, slide, etc.) relative to the floor structure. At locations where the floor support contacts the floor structure, movement of the floor support relative to the floor structure may result in rubbing therebetween. Rubbing may result in vibration of the floor support, the floor structure, and/or components in communication therewith, which a passenger may perceive as a noise (e.g., a squeak, a chirp, etc.). Accordingly, rubbing between the floor support and the floor structure may result from a passenger entering or exiting the passenger compartment of the vehicle, during which the passenger may exert more of (e.g., a higher proportion of) his/her weight upon the floor support as compared to, for example, when the passenger is outside of the vehicle or is seated in the passenger compartment.

Some floor supports may be configured to accommodate vehicles having different sizes and/or geometries (e.g., shapes). For example, some floor supports may be sized to cover multiple floor structures, in which each of the multiple floor structures has a different size and/or geometry. Accordingly, a floor structure may have more freedom to move relative to a first floor structure than to move relative to a second floor structure (e.g., due to a constraining size or geometry of the second floor structure) and, therefore, may be more prone to rubbing when covering the first floor structure than when covering the second floor structure. Additionally, some floor structures may comprise materials different than that of the support structure. Rubbing between dissimilar materials may result in a higher intensity (e.g., a louder, a higher pitch, etc.) vibration than that which results from rubbing between common (e.g., similar) materials. Furthermore, rubbing between certain combinations of materials may result in a higher intensity vibration than that of other combinations.

To prevent or reduce the intensity of vibrations resulting from rubbing between the floor support and the floor structure, an intermediary material is sometimes introduced between the floor support and the floor structure that is configured to enable (e.g., promote) sliding of the floor support relative to the support structure without rubbing. For example, a thin polymer film may be wrapped around the floor support such that the floor support is free from direct contact with the floor structure. The thin polymer film may have different properties (e.g., may be softer, may have a lower coefficient of friction, etc.) than that of the floor support and/or the floor structure to enable the floor support to slide relative to the support structure without substantial rubbing therebetween. However, an intermediary material, such as the thin polymer film, may be prone to unintentionally capturing air (e.g., pockets of air) that may change the effective shape of the floor support and the corresponding fit of the floor support within the passenger compartment. Furthermore, concealing portions (e.g., edges) of the thin polymer film with other aesthetic components, such as carpeting, floor mats, or the like, may be unreliable.

Accordingly, the present disclosure relates to a support structure, such as a floor support, that is configured to cover portions of a floor structure of a vehicle body and/or to provide a uniform surface on which one or more passengers may be supported. The floor support described herein includes one or more standoffs that are configured to space the floor support from the floor structure of the vehicle to, for example, prevent or reduce the intensity of rubbing between the floor support and the floor structure. The one or more standoffs each include legs that define a gap between the floor support and the floor structure. When a force (e.g., a weight) is exerted on the floor support, the legs are configured to deform (e.g., bend) to enable the floor support to move relative to the floor structure while maintaining at least a portion of the gap between the floor support and the floor structure. Accordingly, by maintaining at least some of the gap between the floor support and the floor structure, the one or more standoffs may enable the floor support to move (e.g., shift, slide, etc.) relative to the support structure without rubbing (e.g., without substantial rubbing or with reduced rubbing) and, therefore, without vibration (e.g., without substantial vibration or with reduced intensity vibration). Stated differently, the standoffs described herein may be configured to control movement of the floor support relative to the floor structure when a force is exerted upon the floor support (e.g., to control movement of the floor support toward the floor structure).

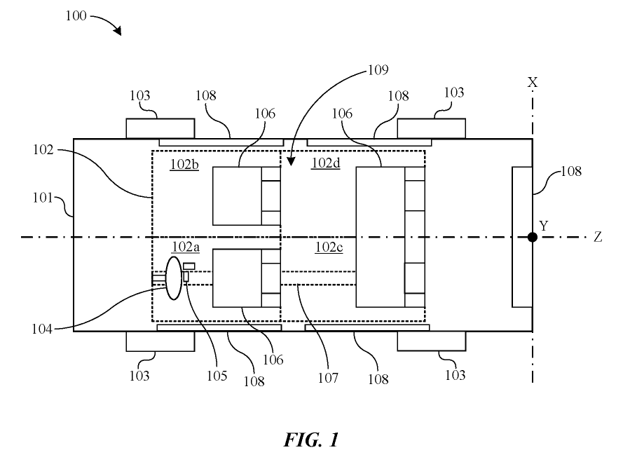

FIG. 1 is a top view schematic illustration of a vehicle 100 that includes a vehicle body 101. The vehicle 100 may be a passenger vehicle that includes a passenger compartment 102 that is configured to carry one or more passengers. Alternatively, the vehicle 100 may be a cargo vehicle that is primarily configured to carry cargo items (e.g., goods, chattel, etc.) in a cargo compartment (not expressly shown), but which also includes the passenger compartment 102 (e.g., for carrying a driver). As another alternative, the vehicle 100 may be a recreational vehicle (an RV) that also includes the passenger compartment 102. In the illustrated implementation, the vehicle 100 is a road-going vehicle in which the vehicle body 101 is supported by wheels 103 (e.g., four of the wheels 103). Although shown with respect to a road-going vehicle, the disclosure herein may be applicable to any suitable vehicle that includes a vehicle body and a passenger compartment. For example, the disclosure herein may be applicable to aerial vehicles, off-road vehicles, marine vehicles, or any other suitable type of vehicle.

The vehicle 100 may include vehicle systems that are connected to the vehicle body 101 and/or the wheels 103 of the vehicle 100 and that cause, control, regulate, or otherwise affect operations of the vehicle 100 (e.g., motion of the vehicle 100, a trajectory of the vehicle 100, etc.). For example, in the illustrated implementation, the vehicle 100 includes a steering system (including a steering wheel 104), a motion system (including a pedal assembly 105), seats 106, and a drivetrain 107.

The vehicle body 101 is a structural component of the vehicle 100 through which other components are interconnected and supported. For example, the vehicle body 101 may include or define the passenger compartment 102 for carrying passengers. The vehicle body 101 may include structural components (e.g., a frame, a subframe, a unibody, a monocoque, etc.) and aesthetic components (e.g., exterior and/or interior body panels). The wheels 103 are connected to the vehicle body 101 by, for example, a suspension system located beneath the vehicle body 101.

The steering system is configured to set or change a trajectory of the vehicle 100 by, for example, setting or changing a steering angle of one or more of the wheels 103 that define the trajectory. The steering system may include the steering wheel 104 that is coupled (e.g., mechanically coupled, electrically coupled) to one or more of the wheels 103 to control the steering angles thereof. For example, the steering system may include a steering shaft that mechanically couples the steering wheel 104 to the front two of the wheels 103 such that rotation of the steering wheel 104 causes a change in the steering angle of the front two of the wheels 103 (e.g., causes the vehicle 100 to turn).

The motion system is configured to cause and/or change motion of the vehicle 100 (e.g., to cause the vehicle 100 to accelerate and/or decelerate). The motion system includes one or more torque generating components (e.g., one or more electric motors, internal combustion engines, hybrid motors, etc.), and the drivetrain 107 is configured to transfer torque generated by the one or more torque generating components to one or more of the wheels 103 to, for example, accelerate the vehicle 100. The motion system also includes one or more braking components configured to apply deceleration torque (e.g., to one or more of the wheels 103) to decelerate the vehicle 100. Examples of braking components include disk brakes, drum brakes, and electric motors configured for regenerative braking.

The motion system may also include the pedal assembly 105 (e.g., including an accelerator pedal, a brake pedal, a clutch, etc.) that is coupled (e.g., mechanically coupled, electrically coupled) to the drivetrain 107 and that is configured to control the transmission of torque generated by the one or more torque generating components to the wheels 103 and/or to control the application of deceleration torque by the one or more braking components. For example, actuation of an accelerator pedal of the pedal assembly 105 may cause more torque to be transmitted to the wheels 103 to accelerate the vehicle 100. As another example, actuation of a brake pedal of the pedal assembly 105 may cause more deceleration torque to be applied to the wheels 103 to decelerate the vehicle 100. The drivetrain 107 may include components operable to transmit torque from the motion system to one or more of the wheels 103. For example, the drivetrain 107 may be coupled to the one or more torque generating components and to one or more of the wheels 103 and may include a driveshaft, a transmission, axles, one or more differentials, or other components.

The vehicle 100 and components thereof (e.g., the vehicle body 101, the passenger compartment 102, etc.) may generally be described herein with respect to an axis X, an axis Y, and an axis Z of the vehicle 100, in which each axis is orthogonal to the other two axes. For example, in the illustrated implementation, the vehicle 100 extends laterally along the axis X to define a width of the vehicle 100, extends vertically along the axis Y to define a height of the vehicle 100, and extends longitudinally along the axis Z to define a length of the vehicle 100, in which the axis Z substantially bisects the vehicle 100. As used herein, the term “lateral direction” refers to a direction that is parallel with the axis X, the terms “vertical direction” and “up-down direction” refer to a direction that is parallel with the axis Y, and the terms “longitudinal direction” and “fore-aft direction” refer to a direction that is parallel with the axis Z.

The terms “inboard” and “outboard” may be used herein to refer to locations with respect to the axis X of the vehicle 100, in which the term “outboard” refers to a location that is further from a YZ-plane (defined by the axis Y and the axis Z) than an “inboard” location. Additionally, as used herein, the term “upper” may be used synonymously with the term “upwards,” and the term “lower” may be used synonymously with the term “downward,” to describe locations with respect to the axis Y of the vehicle 100. For example, the term “upper” may refer to a location that is further from an XZ-plane (defined by the axis X and the axis Z) than a “lower” location. Furthermore, as used herein, the term “fore” may be used synonymously with the terms “forward” and “front,” and the term “aft” may be used synonymously with the terms “rearward,” “rear,” or “back,” to describe locations with respect to the axis Z of the vehicle 100. For example, the term “fore” may refer to a location that is further from an XY-plane (defined by the axis X and the axis Y) than an “aft” location. Finally, when oriented in an upward direction with respect to the axis Y and facing the fore direction with respect to the axis Z, the term “driver-side” may refer to a portion (e.g., a half) of the vehicle 100 located leftward of the axis Z and the term “passenger-side” may refer to a portion (e.g., a half) of the vehicle 100 located rightward of the axis Z.

The passenger compartment 102 may include one or more components of the vehicle 100, such as the steering wheel 104, the pedal assembly 105, and the seats 106. The passenger compartment 102 may generally be divided between one or more sub-compartments, such as a front driver-side sub-compartment 102a, a front passenger-side sub-compartment 102b, a rear driver-side sub-compartment 102c, and a rear passenger-side sub-compartment 102d. Each of the sub-compartments may include one or more of the seats 106 and/or other components of the vehicle 100. For example, in the illustrated implementation, each of the front driver-side sub-compartment 102a and the front passenger-side sub-compartment 102b includes one of the seats 106 and the rear driver-side sub-compartment 102c and the rear passenger-side sub-compartment 102d share one of the seats 106 that extends therebetween (e.g., that is a bench-seat). In other implementations, each of the rear driver-side sub-compartment 102c and the rear passenger-side sub-compartment 102d may include one of the seats 106 (e.g., may each include a bucket-seat).

Furthermore, in the illustrated implementation, the front driver-side sub-compartment 102a includes the steering wheel 104 and the pedal assembly 105. However, in other implementations, such as implementations of the vehicle 100 configured for driving on the left-hand side of the road, the front passenger-side sub-compartment 102b may include the steering wheel 104 and the pedal assembly 105 rather than the front driver-side sub-compartment 102a. Finally, in the illustrated implementation, the drivetrain 107 is located beneath the vehicle body 101 and extends generally in the fore-aft direction beneath the front driver-side sub-compartment 102a and the rear driver-side sub-compartment 102c of the passenger compartment 102.

Although the passenger compartment 102 shown in the illustrated implementation includes four sub-compartments (e.g., the front driver-side sub-compartment 102a, the front passenger-side sub-compartment 102b, the rear driver-side sub-compartment 102c, and the rear passenger-side sub-compartment 102d), the passenger compartment 102 may include any number of sub-compartments. For example, the passenger compartment 102 may include only the front driver-side sub-compartment 102a and the front passenger-side sub-compartment 102b (e.g., may exclude a rear-row). As another example, the passenger compartment 102 may include one or more additional sub-compartments (not shown) located rearward of the rear driver-side sub-compartment 102c and the rear passenger-side sub-compartment 102d (e.g., may include a second-rear row).

The vehicle body 101 may include or define one or more openings through which the passenger compartment 102 may be accessed from outside of the vehicle 100 (e.g., from outside of the passenger compartment 102). The one or more openings may be coverable by one or more respective doors 108. For example, in the illustrated implementation, the vehicle 100 includes five of the doors 108, four of which are located on lateral sides of the vehicle 100 and through which one or more passengers may enter and exit respective sub-compartments of the passenger compartment 102, and one of which is located on a rear longitudinal side of the vehicle 100 and through which cargo may be stored in or removed from a cargo compartment of the vehicle 100 (not expressly shown).

The vehicle body 101 includes a floor structure 109 that forms a lower portion of the vehicle body 101 and that is configured to support one or more passengers, cargo, and/or other components of the vehicle 100. For example, in the illustrated implementation, the floor structure 109 is shown supporting components located in the passenger compartment 102, such as the seats 106, as well as components located outside of the passenger compartment 102, such as the drivetrain 107 (e.g., supported beneath and/or within the floor structure 109). The floor structure 109 may at least partially define the passenger compartment 102 and may provide a structure on which one or more passengers in the passenger compartment 102 may support their weight. The floor structure 109 may include one or more floor pans, cross-members, rails, tunnel reinforcements, wheel housings, and/or other structural components of the vehicle 100. The floor structure 109 may also be referred to herein as a “floor panel” or a “floor pan assembly.”

The floor structure 109 may be configured to transfer forces between portions of the vehicle 100, such as between components of the vehicle body 101, during movement of the vehicle 100. For example, during an abrupt deceleration event (e.g., caused by a force applied to the vehicle body 101) at least a portion of the floor structure 109 may be configured to deform (e.g., crush) to slow the rate of deceleration of remaining portions of the vehicle 100. As another example, during an abrupt deceleration event (e.g., caused by a force applied to the vehicle body 101) at least a portion of the floor structure 109 may be configured to remain rigid (e.g., substantially rigid) to transfer the force between components of the vehicle body 101.

Accordingly, the floor structure 109, or components thereof, may comprise materials having favorable structural characteristics, such as metals (e.g., steel, aluminum, magnesium, and/or alloys or combinations thereof), fiber-reinforced resins (e.g., carbon-fiber, fiberglass, etc.), structural polymers, or combinations thereof. For example, in some implementations, a floor pan and cross-members of the floor structure 109 may comprise steel or an alloy thereof, and a tunnel reinforcement may comprise carbon-fiber. As another example, all of the floor structure 109 may comprise one or more of steel, aluminum, or an alloy or combination thereof. Accordingly, in some implementations, an upper side of the floor structure 109 (e.g., facing the passenger compartment 102) may comprise metal, fiber-reinforced resin, a structural polymer, or a combination thereof.

Furthermore, the floor structure 109, or components thereof, may be shaped to effectuate certain structural, ergonomic, or other characteristics of the floor structure 109. For example, a floor pan of the floor structure 109 may include geometries configured to stiffen the floor structure 109 and/or to provide clearance for other components (e.g., the drivetrain 107). Similarly, rails and cross-members of the floor structure 109 may have channel-shaped and/or tubular geometries to stiffen the floor structure 109. Accordingly, in some implementations, the floor structure 109 (e.g., an upper portion of the floor structure 109) may be irregular (e.g., may not be flat, may include sharp edges, etc.) due to the shapes of components of the floor structure 109. Furthermore, certain components of the floor structure 109 may be unsightly to the one or more passengers within the passenger compartment 102 due to their material composition, geometry, or some other reason. Accordingly, it may be desired that the vehicle 100 include a support structure that is configured to provide a suitable (e.g., uniform, regular, flat, etc.) surface on which the one or more passengers may be supported and that is configured to cover one or more portions of the floor structure 109.

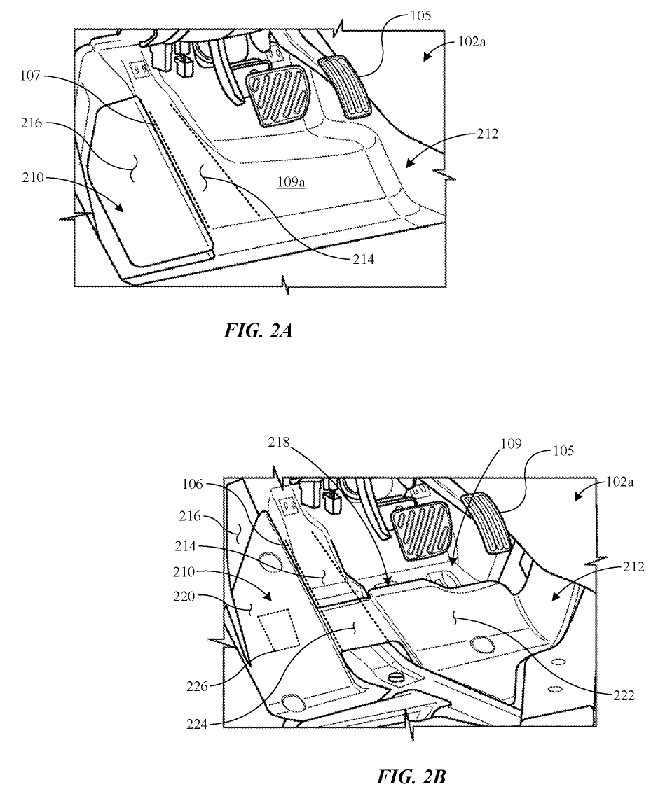

FIG. 2A is an upper perspective view illustration of the front driver-side sub-compartment 102a of the vehicle 100. In the illustrated implementation, the front driver-side sub-compartment 102a includes the pedal assembly 105 and includes a front driver-side floor portion 109a of the floor structure 109 that is located within the front driver-side sub-compartment 102a. The front driver-side floor portion 109a includes an outboard region 210 and an inboard region 212, in which the outboard region 210 is located outboard relative to the inboard region 212. As indicated by dotted lines, the drivetrain 107 is located centrally beneath the front driver-side floor portion 109a and extends in the fore-aft direction. Accordingly, as shown, the front driver-side floor portion 109a may include a tunnel 214 through which the drivetrain 107 is configured to extend. The tunnel 214 may be or comprise a raised region of the front driver-side floor portion 109a that provides clearance for the drivetrain 107 (e.g., a driveshaft of the drivetrain 107) to extend.

In some implementations, the floor structure 109 may include a footrest 216. The footrest 216 is a portion of the floor structure 109 that is configured to bear the weight of a passenger or a portion (e.g., a foot and/or a leg) thereof. For example, in the illustrated implementation, the front driver-side floor portion 109a includes the footrest 216 located at the outboard region 210 thereof, in which the footrest 216 comprises a raised region on which a driver may rest his/her left leg while seated. The footrest 216 may be located adjacent to an outboard edge of the front driver-side floor portion 109a (e.g., adjacent to a doorsill of the vehicle body 101). In the illustrated implementation, the footrest 216 is located outboard of the tunnel 214 and the pedal assembly 105 and inboard of the opening for the front driver-side sub-compartment 102a (e.g., coverable by one of the doors 108 in FIG. 1). In other words, the footrest 216 may be located between the tunnel 214 and the opening for the front driver-side sub-compartment 102a.

The footrest 216 may also include one or more other geometries (e.g., may take the form of one or more other shapes). For example, in the illustrated implementation, the footrest 216 is angled in the fore-aft direction, such that an upper surface thereof generally slopes upward from a rear location of the front driver-side floor portion 109a toward a front location of the front driver-side floor portion 109a. In other words, the footrest 216 may be taller (e.g., may extend prouder of a remainder of the front driver-side floor portion 109a) at a front location of the front driver-side floor portion 109a than at a rear location of the front driver-side floor portion 109a. By angling the footrest 216, a foot of a driver may comfortably rest upon the footrest 216 when the driver is seated in the front driver-side sub-compartment 102a of the vehicle 100 (e.g., may position the foot to be substantially perpendicular to a calf/shin region of the leg of the driver). Furthermore, angling the footrest 216 may enable a force (e.g., caused by or resulting from a high deceleration event) to be transferred to the leg of the driver while the foot is angled relative to an XZ plane (defined by the axis X and the axis Z, see FIG. 1) rather than at some other orientation.

The front driver-side floor portion 109a of the floor structure 109 may also include other geometries, such as stepped portions, recessed portions, or other raised portions that are independent of, or formed with, the tunnel 214 and/or the footrest 216. For example, in the illustrated implementation, the front driver-side floor portion 109a includes a recessed portion located forward of the pedal assembly 105 (e.g., to provide clearance for actuation of pedals thereof) and a stepped region below and rearward of the pedal assembly 105 (e.g., to enable a foot to move between pedals of the pedal assembly 105).

FIG. 2B is an upper perspective view illustration of the front driver-side sub-compartment 102a of the vehicle 100 including a floor support 218. As indicated previously, the floor structure 109 (e.g., an upper portion of the floor structure 109) may be unsightly and/or irregular. Accordingly, it may be desired to cover portions of the floor structure 109, such as one or more portions of the front driver-side floor portion 109a, with a support structure, such as the floor support 218. The floor support 218 may also be configured to provide a uniform (e.g., flat, regular) surface on which passengers in the passenger compartment 102 may be supported.

The floor support 218 may include one or more panels that are configured to cover corresponding portions of the floor structure 109. For example, in the illustrated implementation, the floor support 218 includes an outboard panel 220 that is configured to cover some or all of the outboard region 210 of the front driver-side floor portion 109a, includes an inboard panel 222 that is configured to cover some or all of the inboard region 212 of the front driver-side floor portion 109a, and includes a bridge panel 224 that is configured to cover some or all of the tunnel 214 of the front driver-side floor portion 109a. Accordingly, in some implementations, the bridge panel 224 may be configured to extend over the drivetrain 107 of the vehicle 100. The bridge panel 224 may extend between the outboard panel 220 and the inboard panel 222 to provide a structural connection therebetween.

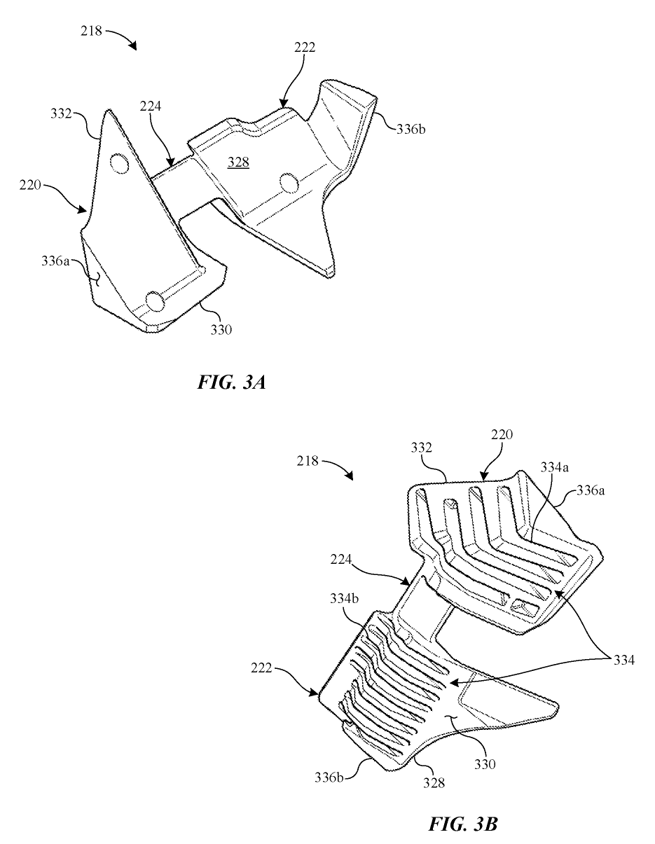

The floor support 218 may include portions that match (e.g., substantially match) the geometry of the floor structure 109. For example, the outboard panel 220 of the floor support 218, or portions thereof, may be shaped to match the geometry of the outboard region 210 of the front driver-side floor portion 109a; the inboard panel 222 of the floor support 218, or portions thereof, may match the geometry of the inboard region 212 of the front driver-side floor portion 109a; and the bridge panel 224 of the floor support 218, or portions thereof, may match the geometry of the tunnel 214 of the front driver-side floor portion 109a. As is described in further detail with respect to FIGS. 3A-3B, in some implementations only a lower surface of the floor support 218 may match the geometry of the floor structure 109, and an upper surface of the floor support 218 may have some other geometry (e.g., a flat or uniform geometry).

During ingress or egress of a passenger into or out of the passenger compartment 102, the passenger may exert his/her weight upon the floor support 218 (e.g., the floor support 218 may bear the weight of the passenger). For example, a driver may step upon the floor support 218 while entering the front driver-side sub-compartment 102a from outside of the vehicle 100 to, for example, transfer his/her weight onto one of the seats 106 (see FIG. 1). Where the footrest 216 is located at the outboard region 210 of the front driver-side floor portion 109a (as shown in FIGS. 2A-2B), because the footrest 216 may be the most convenient location of the front driver-side floor portion 109a for which the driver to step, the driver may exert his/her weight upon the outboard panel 220 of the floor support 218 while entering or exiting the front driver-side sub-compartment 102a. An example of an area 232 on which the driver may step when entering or exiting the front driver-side sub-compartment 102a is depicted in FIG. 2A with dotted lines.

As indicated previously, when a force is exerted upon the floor support 218, the floor support 218 may move relative to the floor structure 109, for example, due to the floor support 218 being configured for use on other implementations of a passenger compartment, vehicle body, and/or floor structure. Furthermore, in the illustrated implementation, the floor support 218 is free from means for positionally securing the floor support 218 relative to the floor structure 109 (e.g., the front driver-side floor portion 109a). For example, the floor support 218 is free from fasteners, adhesives, or the like for positionally securing the floor support 218 to the front driver-side floor portion 109a. Accordingly, the floor support 218 may be moveable relative to the floor structure 109. Furthermore, when a force (e.g., a weight of a passenger) is exerted upon the floor support 218 (e.g., when the floor support 218 bears a weight), the floor support 218 may move relative to the floor structure 109, which may result in rubbing.

FIGS. 3A-3B are upper and lower perspective view illustrations of the floor support 218. The floor support 218 includes an upper surface 328 and a lower surface 330, in which the lower surface 330 is opposite the upper surface 328. When the floor support 218 is installed in the vehicle 100 (e.g., in the passenger compartment 102) the upper surface 328 may face the passenger compartment 102 and may be referred to herein as an “interior surface,” and the lower surface 330 may face the vehicle body 101 (e.g., the floor structure 109 of the vehicle body 101) and may be referred to herein as an “exterior surface.” As described previously, the floor support 218 may include one or more portions referred to herein as respective panels (e.g., the outboard panel 220, the inboard panel 222, and/or the bridge panel 224). Each of the panels may be substantially flat and may have contours (e.g., may have curvilinear geometries) to define a topography of the floor support 218 (e.g., a panel geometry of the floor support 218). In some implementations, the topography of the floor support 218 (e.g., the panel geometry of the floor support 218) may substantially match a topography of a corresponding portion of the floor structure 109 (e.g., the front driver-side floor portion 109a). The floor support 218 may be formed from a structural polymer, such as polystyrene (e.g., expanded polystyrene), polyethylene, polypropylene (e.g., expanded polypropylene), or a combination thereof. Other materials may be used.

As indicated previously with respect to FIG. 2B, the lower surface 330 of the floor support 218 may be shaped to match (e.g., substantially match) a geometry of the floor structure 109 (e.g., a topography of the floor structure 109) or one or more portions thereof (e.g., the front driver-side floor portion 109a). For example, in the implementation shown in FIGS. 2A-2B, the front driver-side floor portion 109a includes the footrest 216 located at the outboard region 210 and includes a stepped region below and rearward of the pedal assembly 105. Accordingly, the lower surface 330 of the floor support 218, or portions thereof (e.g., the outboard panel 220), may match the geometry of the footrest 216 to define a footrest portion 332 of the floor support 218, which may be referred to herein as a geometric portion of the floor support 218. Furthermore, the inboard panel 222 of the floor support 218, or portions thereof, may match the geometry of the stepped region.

The floor support 218 may also include one or more ribs 334 that are configured to support (e.g., stiffen) the floor support 218 or portions thereof. For example, in the illustrated implementation, the outboard panel 220 includes outboard ribs 334a (e.g., four of the outboard ribs 334a) and the inboard panel 222 includes inboard ribs 334b (e.g., eight of the inboard ribs 334b). As shown, the ribs 334 may extend in the longitudinal direction along the lower surface 330 of the floor support 218. The ribs 334 may be configured to increase the bending stiffness of the floor support 218 in one or more directions (e.g., in the longitudinal direction). Furthermore, the ribs 334 may be configured for transferring and/or changing a force (e.g., resulting or caused by a force exerted upon the vehicle body 101, see FIG. 1) from the floor structure 109 to the foot and/or leg of the passenger (e.g., the driver). In some implementations, the ribs 334 may include portions of the lower surface 330 of the floor support 218 such that the ribs 334 may define portions of the lower surface 330 that match portions of the floor structure 109. For example, the footrest portion 332 of the floor support 218 may include the outboard ribs 334a such that the outboard ribs 334a define a portion of the lower surface 330 that matches the footrest 216.

In some implementations, the floor support 218 may include locating geometries 336 that are configured to locate the floor support 218 within the passenger compartment 102 (e.g., on the floor structure 109). For example, the locating geometries 336 may be configured to interface with corresponding geometries of the vehicle 100 (e.g., the vehicle body 101) to locate the floor support 218 on the floor structure 109. In the illustrated implementation, the floor support 218 includes an outboard locating geometry 336a that comprises a substantially vertical wall and that is configured to interface with an interior body panel of the vehicle body 101. The floor support 218 shown in FIGS. 2A-2B also includes an inboard locating geometry 336b that comprises an elongate member that extends upwards and that is configured to interface with a wall of a consol of the vehicle 100.

When the floor support 218 is installed within the passenger compartment 102 (e.g., as shown in FIG. 2B), the outboard locating geometry 336a and the inboard locating geometry 336b may cooperatively locate the floor support 218 on the floor structure 109. However, as indicated previously, despite the locating geometries 336, the floor support 218 may be sized such that the floor support 218 is moveable relative to the floor structure 109 when installed in the passenger compartment 102. Furthermore, as indicated previously with respect to FIG. 2B, the floor support 218 may be free from means for positionally securing the floor support 218 relative to the floor structure 109. Accordingly, in some implementations, the floor support 218 may be configured to move (e.g., shift, slide, etc.) relative to the floor structure 109 when a force is exerted upon the floor support 218, which may result in rubbing between the lower surface 330 of the floor support 218 and the floor structure 109. Rubbing between the lower surface 330 of the floor support 218 and the floor structure 109 may result in vibration of the floor support 218 and/or the floor structure 109, which may be perceived by a passenger (e.g., a driver) as a noise (e.g., a squeak, a chirp, etc.).

The floor support 218 may be more prone to vibration and/or producing a higher intensity (e.g., louder) noise when formed from some materials as compared to when formed from other materials. For example, the floor support 218 may be more prone to rubbing and/or producing a higher intensity noise when the floor support 218 is formed from expanded polystyrene (EPS) than when formed from polystyrene (PS), polystyrene and polyethylene (PS + PE), polypropylene (PP), or expanded polypropylene (EPP). Furthermore, the floor support 218 may be more prone to rubbing and/or producing a higher intensity noise when the floor structure 109 (e.g., an upper portion of the floor structure 109) is formed from metal (e.g., E-coated steel, painted steel, or bare aluminum/steel).

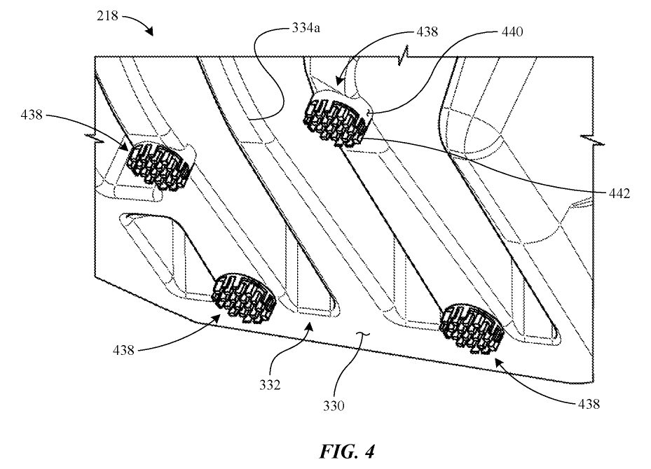

FIG. 4 is a lower perspective view illustration of the floor support 218 including multiple standoffs 438 (e.g., four of the standoffs 438). As indicated previously, to prevent or reduce the intensity of rubbing between the floor support 218 and the floor structure 109, the floor support 218 may include one or more of the standoffs 438 (e.g., one of the standoffs 438, three of the standoffs 438, four of the standoffs 438, ten of the standoffs 438, etc.) that are configured to space the floor support 218 from the floor structure 109. The standoffs 438 may be disposed along the lower surface 330 of the floor support 218 and, in some implementations, may be spaced apart from one another on the lower surface 330. Each of the standoffs 438 may extend away from the lower surface 330, for example, in a downward direction or in a direction that is generally perpendicular (e.g., normal) to the lower surface 330. In the illustrated implementation, the standoffs 438 are disposed on the outboard ribs 334a (located on the footrest portion 332 of the floor support 218) which include portions of the lower surface 330.

The standoffs 438 may be formed with the floor support 218 (e.g., with the lower surface 330 of the floor support 218), or may be a separate component of the vehicle 100. Stated differently, the standoffs 438 may be formed unitarily with the floor support 218 or may be formed separately from the floor support 218. Where the standoffs 438 are separate from the floor support 218, the standoffs 438 may be connected to the lower surface 330 via any suitable means, such as adhesives, snaps, fasteners, or the like. In some implementations, the standoffs 438 may be removably connectable to the lower surface 330 of the floor support 218. Furthermore, where the standoffs 438 are separate from the floor support 218, the standoffs 438 may be formed from the same materials as described above with respect to the floor support 218 or may be formed from a different material.

Each of the standoffs 438 may include a base 440 and legs 442 that extend away from the base 440. The legs 442 may extend away from the base 440 in the same direction that the respective one of the standoffs 438 for which it is included extend from the lower surface 330 of the floor support 218. Stated differently, one of the standoffs 438 may extend from the lower surface 330 to define a first axis and the legs 442 thereof may extend from the base 440 to define a second axis, in which the first axis and the second axis are aligned (e.g., axially aligned). For example, in the illustrated implementation, each of the standoffs 438 include many of the legs 442 (e.g., twenty-five of the legs 442) that each extend linearly away from the base 440. In some implementations, the base 440 of some or more of the standoffs 438 may be excluded, such that the legs 442 thereof extend direction from the lower surface 330 of the floor support 218. Each of the legs 442 may be an independent (e.g., discrete) deformable member that is spaced from the other of the legs 442. Accordingly, the legs 442 may be referred to herein as discrete supports. As shown, the base 440 of each of the standoffs 438 may be substantially cylindrical. However, in other implementations, the base 440 may be some other shape (e.g., rectangular, elliptical, irregular, etc.).

In some implementations, the standoffs 438 (e.g., the legs 442 thereof) may extend to cover large portions of the lower surface 330 of the floor support 218. For example, in some implementations, one or more of the standoffs 438 may extend along the lower surface 330 to cover an entirety of, or substantial portions of, the lower surface 330 of the floor support 218. In other implementations, one or more of the standoffs 438 may extend along the lower surface 330 to cover an entirety of, or substantial portions of, the lower surface 330 of one of the panels of the floor support 218 (e.g., one of the outboard panel 220, the inboard panel 222, or the bridge panel 224).

As is described in further detail below, the standoffs 438 and/or the legs 442 thereof are configured to define a gap between the lower surface 330 of the floor support 218 and the floor structure 109 of the vehicle 100 (see FIG. 2A) when the floor support 218 is installed in the passenger compartment 102. The legs 442 of each of the standoffs 438 may be configured to contact the floor structure 109, and upon a force being exerted upon the floor support 218, the legs 442 may be configured to deform (e.g., bend) to enable the floor support 218 to move (e.g., shift) relative to the floor structure 109 while maintaining at least some of the gap. Accordingly, the standoffs 438 may be configured to reduce rubbing between the floor support 218 and the floor structure 109 and, therefore, prevent or reduce the intensity of vibrations therebetween.

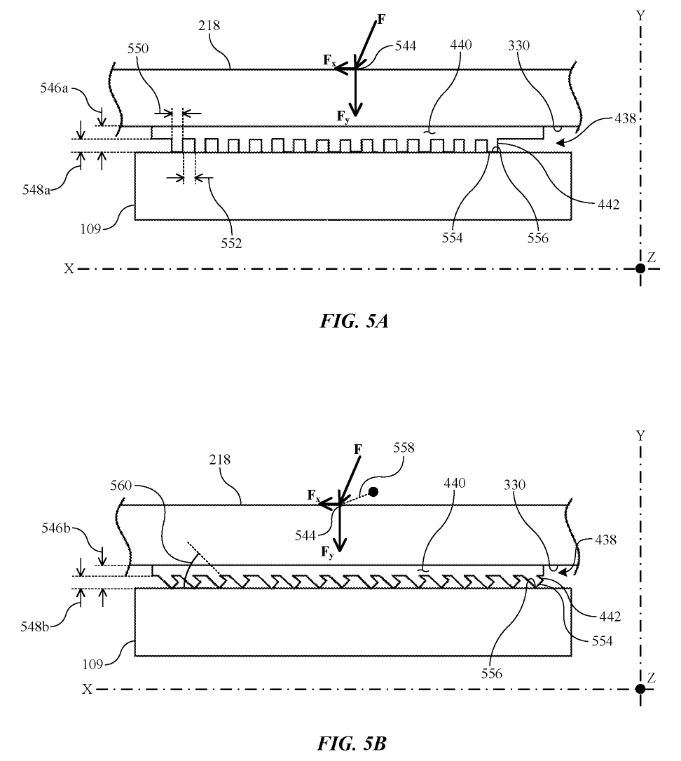

FIGS. 5A-5B are side view illustrations of an example of the floor support 218 including one of the standoffs 438 and showing the legs 442 thereof deforming (e.g., bending) in response to the floor support 218 receiving a force F at a location 544. In the illustrated implementation, the floor support 218 receives (e.g., bears) the force F at the location 544, in which the force F is at an angle. Accordingly, the force F includes an x-component Fₓ directed in the lateral direction and a y-component F_{y} directed downward in the up-down direction. The force F may correspond to a passenger (e.g., a driver) exerting his/her weight upon the floor support 218 (e.g., at the area 226 shown in FIG. 2B). In some implementations, the force F may correspond to an increase in force (e.g., an increase in weight) applied to the floor support 218. For example, the force F may correspond to a driver shifting a higher proportion of his/her weight upon the floor support 218 when exiting the front driver-side passenger sub-compartment 102a than when seated therein.

Referring to FIG. 5A, prior to deformation of the legs 442 (e.g., prior to application of the force F on the floor support 218), the standoff 438 may have a nominal thickness 546a that defines a nominal gap between the lower surface 330 of the floor support 418 and the floor structure 109. The nominal thickness 546a of the standoff 438 may comprise a nominal leg thickness 548a that defines a nominal leg gap between the base 440 and the floor structure 109. In the illustrated implementation, each of the legs 442 of the standoff 438 has a width 550. Furthermore, the legs 442 of the standoff 438 are spaced from one another by a distance 552. In some implementations, the nominal leg thickness 548a may be greater than or equal to the distance 552. In other implementations, the nominal leg thickness 548a may be less than or equal to the distance 552.

The legs 442 may extend from the base 440 to define respective terminal ends of each of the legs 442 that define respective contact surfaces 554 configured to contact the floor structure 109 at respective contact locations 556 when the floor support 218 is installed in the passenger compartment 102. In some implementations, the contact surface 554 of each of the legs 442 may comprise a different material than that of a remainder of the legs 442 and/or the standoff 438. For example, the contact surface 554 may comprise a material having a higher coefficient of friction than that of a remainder of the legs 442 and/or the standoff 438 (e.g., may comprise rubber, etc.). Furthermore, in some implementations, the contact surface 554 may comprise a texture that increases friction between the contact surface 554 and the floor structure 109. Although the contact surface 554 of each of the legs 442 in FIGS. 5A-5B are shown contacting the floor structure 109, in some implementations, one or more of the legs 442 may not contact the floor structure 109.

Referring to FIG. 5B, when the force F is applied to the floor support 218 (e.g., at the location 544), the floor support 218 may move (e.g., shift, slide) relative to the floor structure 109, for example, along line 558. As shown, when the force F is applied to the floor support 218, the legs 442 may deform (e.g., bend) such as to define a depressed thickness 546b of the standoff 438 corresponding to a depressed gap between the lower surface 330 and the floor structure 109. Furthermore, deformation (e.g., bending) of the legs 442 may result in a depressed leg thickness 548b of the legs 442 that defines a depressed leg gap between the base 440 and the floor structure 109. As shown, the depressed thickness 546b of the standoff 438 is smaller than the nominal thickness 546a of the standoff 438, and the depressed leg thickness 548b of the legs 442 is smaller than the nominal leg thickness 548a of the legs 442.

When the force F is applied to the floor support 218, the contact surface 554 of the legs 442 are configured to remain in contact (e.g., in substantial contact) with the floor structure 109 such that the contact surface 554 is positionally fixed (e.g., substantially positionally fixed) relative to the floor structure 109 at the contact location 556 (e.g., is not substantially movable, slidable, etc. relative to the floor structure 109). Accordingly, movement of the base 440 with the floor support 218 (e.g., along the line 558) may cause each of the legs 442 to pivot (e.g., rotate) relative to the contact location 556. Accordingly, one or more of the legs 442 may deform (e.g., bend) to an angle 560 relative to the floor structure 109 and/or relative to the lower surface 330 of the floor support 218. By maintaining at least the depressed gap (e.g., defined by the depressed thickness 546b) between the lower surface 330 of the floor support 218 and the floor structure 109 when the force F is applied to the floor support 218, rubbing between the lower surface 330 of the floor support 218 and the floor structure 109 may be prevented and/or reduced.

As described previously, the standoff 438 may also be configured to control movement of the floor support 218 relative to the floor structure 109 (e.g., toward the floor structure 109). When the force F is applied to the floor support 218 (e.g., at the location 544), deformation of the legs 442 may result in the standoff 438 (e.g., the legs 442) exerting a reaction force upon the floor support 218 (e.g., upon the lower surface 330 of the floor support 218) that is generally opposite that of the force F. Accordingly, the standoff 438 may be configured to resist (e.g., slow, dampen, etc.) movement of the floor support 218 relative to the floor structure 109 when the force F is exerted upon the floor support 218. In some implementations, the standoff 438 may be configured to exert a reaction force in only certain directions. For example, the standoff 438 may be configured to exert a reaction force only in the up-down direction to, for example, resist movement of the floor support 218 relative to the floor structure 109 caused by the y-component F_{y} of the force F. In some implementations, each of the legs 442 may be configured to exert a reaction force in response to the force F that is different than other of the reaction forces exerted by other of the legs 442. Furthermore, in some implementations, the standoff 438 may be configured to transfer and/or change characteristics of a force (e.g., caused or resulting from a high deceleration event) transferred from the floor structure 109 to the floor support 218 and/or to the foot and/or leg of a passenger (e.g., a driver).

Although the legs 442 of the standoff 438 each shown reacting uniformly (e.g., each bending to the angle 560), as described previously, each of the legs 442 may be independent (e.g., discrete) and therefore may each deform (e.g., bend) to a different angle or may deform in other ways not expressly shown. For example, some of the legs 442 may deform more than others of the legs 442 such that some of the legs 442 bend to a larger angle than other of the legs 442. As another example, some of the legs 442 may be compressed in the up-down direction (e.g., as a result of the y-component F_{y} of the force F). The deformation characteristics of the legs 442 depend upon several factors, such as the geometry of the floor structure 109, the geometry of the lower surface 330 of the floor support 218, the nominal leg thickness 548a of each of the legs 442, and/or other factors.

The distance at which the floor support 218 moves (e.g., is movable) relative to the floor structure 109 as a result of the force F (e.g., represented in FIG. 5B as a length of the line 558) may be dependent upon the nominal leg thickness 548a of the legs 442. Stated differently, an amount that the floor support 218 may be moveable relative the floor structure 109 may be limited at least in part by the nominal leg thickness 548a of the legs 442. Furthermore, in some implementations, the angle 560 to which the legs 442 may bend in response to the force F, and thus the distance at which the floor support 218 moves relative to the floor structure 109, may be limited via contact with adjacent ones of the legs 442. Accordingly, the angle 560 to which the legs 442 may bend in response to the force F, and thus the distance at which the floor support 218 may move relative to the floor structure 109, may also be dependent upon the distance 552 between the legs 442 of the standoff 438. In some implementations, deformation (e.g., bending) of the legs 442 may be the result of only the x-component Fₓ of the force F. Furthermore, although the force F shown in FIGS. 5A-5B includes only the x-component Fₓ and the y-component F_{y}, the force F may be applied at some other angle relative to the floor support 218 and thus may have more or fewer components (e.g., may have a z-component). Where the force F is applied to the floor support 218 at another angle, the legs 442 may nevertheless deform (e.g., bend) similarly to as described with respect to FIGS. 5A-5B.

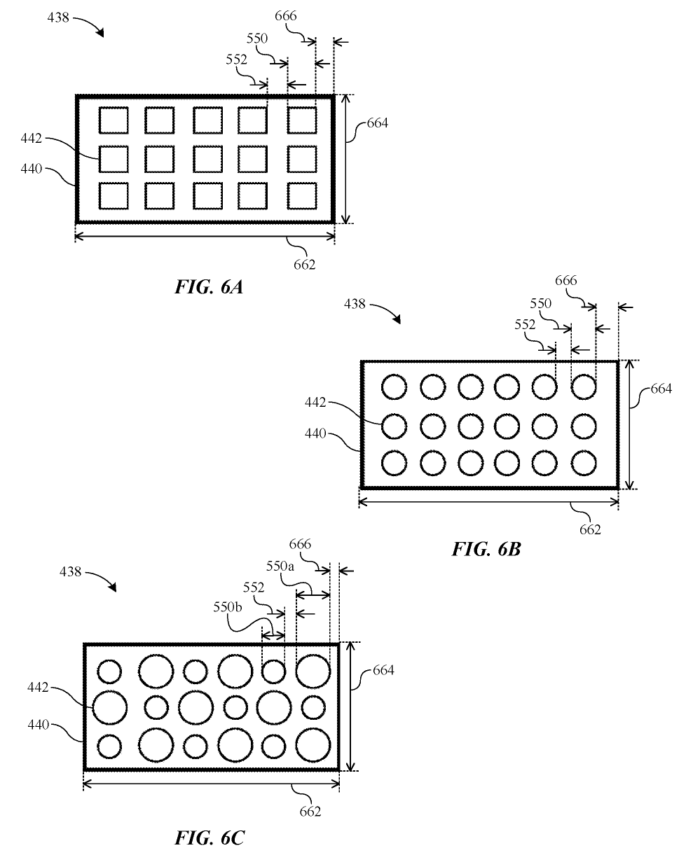

FIGS. 6A-6C are bottom view illustrations of examples of the standoffs 438. In the illustrated implementations, the base 440 of the standoffs 438 are rectangular, having a length 662 and a width 664. In each of the illustrated implementations, the legs 442 of the standoff 438 that are adjacent to a peripheral edge of the base 440 are spaced from the peripheral edge by an edge distance 666. The legs 442 of the standoffs 438 may have any suitable cross-sectional geometry (e.g., shape). For example, in the implementation shown in FIG. 6A, each of the legs 442 is square (e.g., has a square cross-section) having the width 550 and spaced from adjacent ones of the legs 442 by the distance 552. As another example, in the implementation shown in FIG. 6B, each of the legs 442 is circular (e.g., has a circular cross-section) having the width 550 (here, a diameter) and spaced from adjacent ones of the legs 442 by the distance 552. In some implementations, some of the legs 442 of the standoffs 438 may have a different shape and/or size than other of the legs 442 of the standoffs. For example, in the implementation shown in FIG. 6C, some of the legs 442 have a first width 550a that is larger than other of the legs 442 that have a second width 550b.

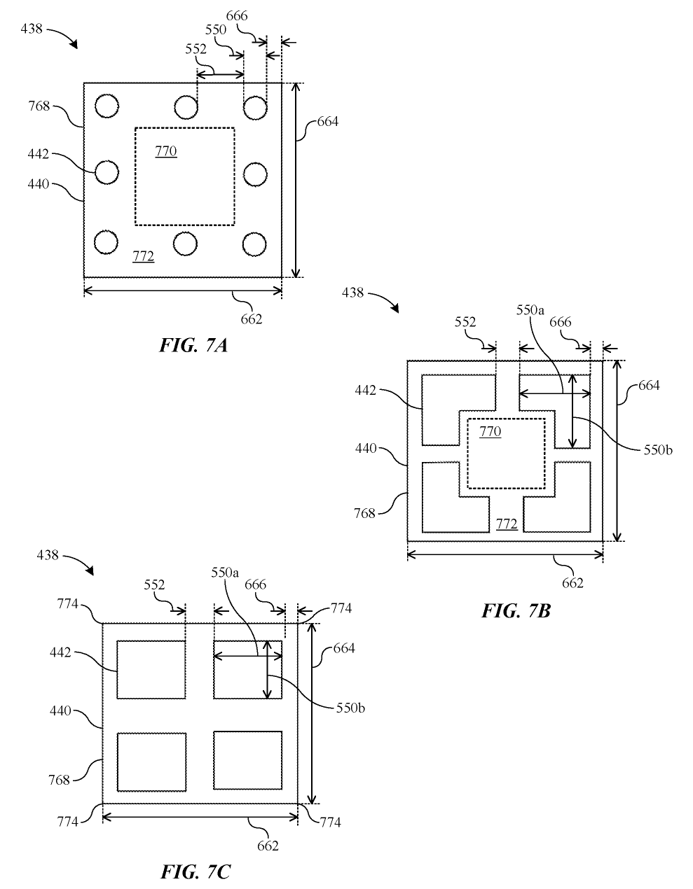

FIGS. 7A-7C are bottom view illustrations of further examples of the standoffs 438. In the illustrated implementations, the base 440 of the standoffs 438 are square, having the length 662 and the width 664 that are substantially the same. In each of the illustrated implementations, the legs 442 of the standoffs 438 that are adjacent to a peripheral edge 768 of the base 440 are spaced from the peripheral edge by the edge distance 666. The base 440 may include or define a central area 770 that is located centrally on a bottom surface of the base 440. In some implementations, the legs 442 of the standoff 438 may be disposed along a peripheral area 772 of the base 440 that surrounds the central area 770 and that extends along the peripheral edge 768 of the base 440.

For example, in the implementation shown in FIG. 7A, the legs 442 are circular (e.g., have circular cross-sections), having the width 550 (here, a diameter), are spaced along the peripheral area 772 of the base 440, and are spaced from one another by the distance 552. As another example, in the implementation shown in FIG. 7B, the legs 442 are polygon shaped, having a first width 550a and a second width 550b, and are spaced along the peripheral area 772 of the base 440 by the distance 552. In other implementations, the legs 442 may be positioned at corners 774 of the base 440. For example, in the implementation shown in FIG. 7C, the legs 442 are rectangular, having a first width 550a and a second width 550b, and are positioned at the corners 774 of the base 440 and are spaced from one another by the distance 552.

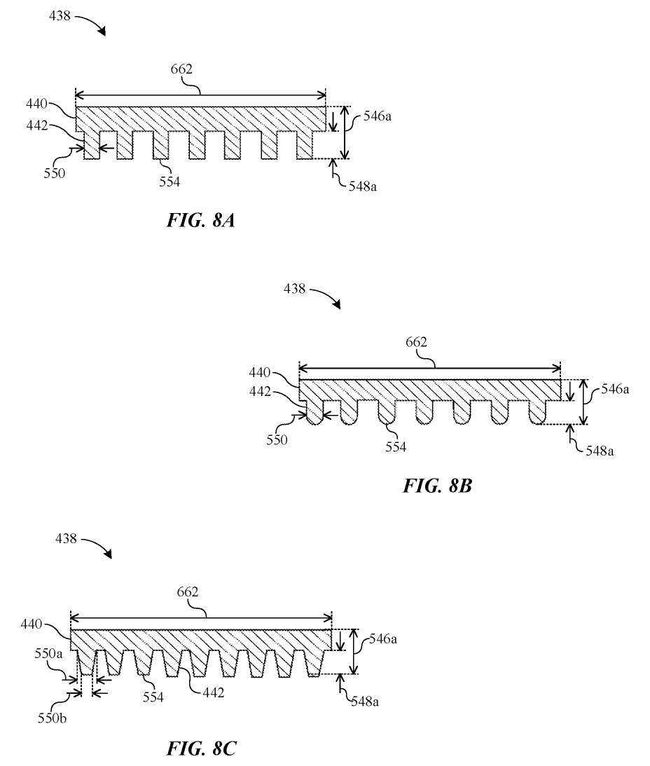

FIGS. 8A-8C are side cross-section view illustrations of examples of standoffs 438. In the illustrated implementations, the standoffs 438 have the nominal thickness 546a and have the legs 442 that each extend from the base 440 to the nominal leg thickness 548a to terminate at the contact surface 554. The base 440 of the standoffs 438 have the length 662 and may have a base thickness defined as the nominal thickness 546a less the nominal leg thickness 548a. In some implementations, the nominal leg thickness 548a may be larger than the base thickness.

As indicated previously with respect to FIGS. 6A-6B, the legs 442 may have any suitable shape. For example, in the implementation shown in FIG. 8A, the side profile of each of the legs 442 is rectangular and has the width 550 (e.g., a diameter). As another example, in the implementation shown in FIG. 8B, the contact surface 554 of each of the legs 442 is rounded such as to have a rounded side profile. The contact surface 554 may be rounded to promote pivoting of the legs 442 when a force (e.g., the force F) is applied to the floor support 218 (e.g., as described with respect to the FIGS. 5A-5B). As yet another example, in the implementation shown in FIG. 8C, the legs 442 may taper as the legs 442 extend away from the base 440, such that a first width 550a (e.g., a first diameter) at an upper end of each of the legs 442 is larger than a second width 550b (e.g., a second diameter) at a lower end of each of the legs 442.

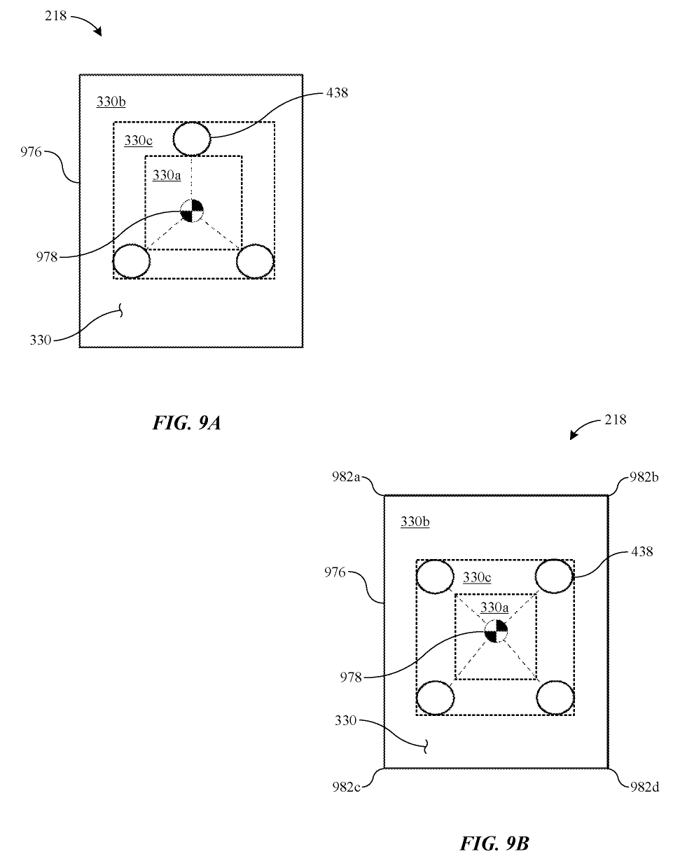

FIGS. 9A-9B are bottom view illustrations of examples of the floor support 218. In the illustrated implementations, the floor support 218 includes the lower surface 330, in which the lower surface 330 includes a peripheral edge 976. The peripheral edge 976 may represent a peripheral edge of the floor support 218 or a peripheral edge of a panel of the floor support 218 (e.g., a peripheral edge of the outboard panel 220, the inboard panel 222, or the bridge panel 224). The floor supports 218 shown in FIGS. 9A-9B are spaced on the lower surface 330 of the floor support 218 such as to define a center of mass 978 of the floor support 218 and/or one of the panels of the floor support 218 (e.g., the outboard panel 220, the inboard panel 222, or the bridge panel 224). The floor support 218 shown in FIG. 9A includes three of the standoffs 438 and the floor support 218 shown in FIG. 9B includes four of the standoffs 438.

The center of mass 978 represents a central point between the standoffs 438 that, if is located outside of a central region 330a, may result in rocking (e.g., pivoting) of the floor support 218 or the corresponding panel when a force is exerted upon the floor support 218. When the center of mass 978 is located within the central region 330a, the floor support 218 may be substantially stable when installed within the passenger compartment 102. The central region 330a may be defined by the locations of the standoffs 438 on the lower surface 330. Accordingly, the standoffs 438 may be disposed on the lower surface 330 such that the corresponding center of mass 978 is located within the central region 330a. Between the central region 330a and the peripheral edge 976, the lower surface 330 may include or define a peripheral region 330b that extends along the peripheral edge 976. Furthermore, the standoffs 438 may define a standoff region 330c that extends around the standoffs 438. In some implementations, the peripheral region 330b may include the standoff region 330c, or portions thereof. In the illustrated implementations, for example, the standoffs 438 are disposed on the peripheral region 330b, in which the peripheral region 330b includes the standoff region 330c. In some implementations, the standoffs 438 may be configured to space the central region 330a and/or the standoff region 330c from the floor structure 109 such that the central region 330a and/or the standoff region 330c are free from contact with the floor structure 109. In the implementation shown in FIG. 9B, each of the standoffs 438 are positioned at respective corners 982 of the peripheral edge 976 and are also located within the peripheral region 330b of the lower surface 330.

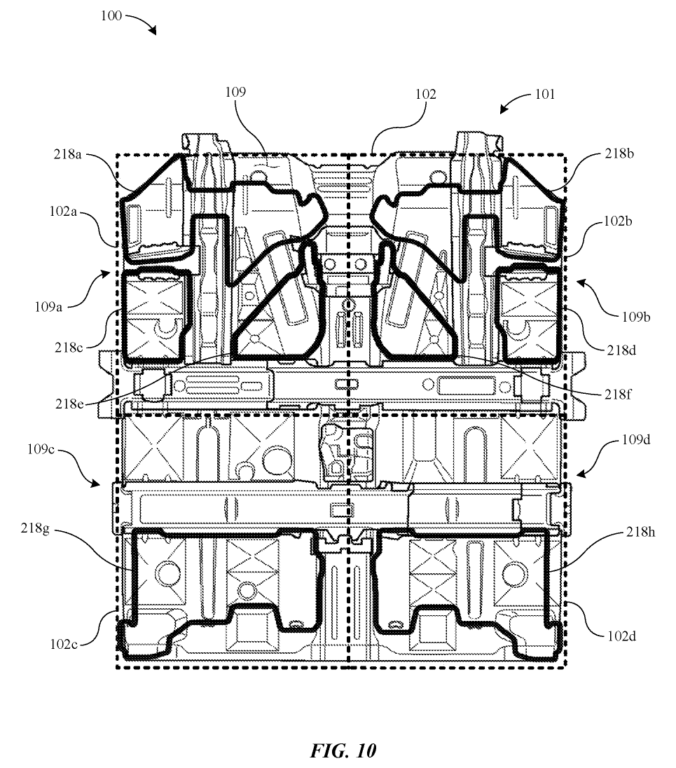

FIG. 10 is a top view illustration of an example of the vehicle 100 including the vehicle body 101. Although the floor support 218 has been shown as being configured to cover the front drivers-side floor portion 109a of the floor structure 109 within the front driver-side sub-compartment 102a of the passenger compartment 102, other implementations of the floor support 218 may be configured to cover other portions of the floor structure 109 within the same or other sub-compartments of the passenger compartment 102. For example, in the implementation shown in FIG. 10, the floor support 218 is depicted as a first floor support 218a covering a portion of the front driver-side floor portion 109a within the front driver-side sub-compartment 102a. The vehicle 100 may also include a second floor support 218b that is configured to cover a portion of a front passenger-side floor portion 109b within the front passenger-side sub-compartment 102b. The vehicle 100 may also include a third floor support 218c that is configured to cover another portion of the front driver-side floor portion 109a within the front driver-side sub-compartment 102a. The vehicle 100 may also include a fourth floor support 218d that is configured to cover another portion of the front passenger-side floor portion 109b within the front passenger-side sub-compartment 102b.

The vehicle 100 may also include a fifth floor support 218e that is configured to cover another portion of the front driver-side floor portion 109a within the front driver-side sub-compartment 102a. The vehicle 100 may also include a sixth floor support 218f that is configured to cover another portion of the front passenger-side floor portion 109b within the front passenger-side sub-compartment 102b. The vehicle 100 may also include a seventh floor support 218g that is configured to cover a portion of a rear driver-side floor portion 109c within the rear driver-side sub-compartment 102c. The vehicle 100 may also include an eighth floor support 218h that is configured to cover a portion of a rear passenger-side floor portion 109d within the rear passenger-side sub-compartment 102d.

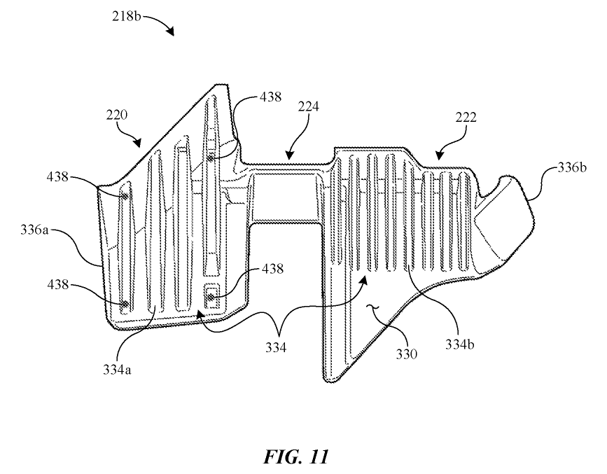

FIG. 11 is a bottom view illustration of the second floor support 218b. The second floor support 218b may be a mirror implementation of the first floor support 218a (e.g., the floor support 218). Accordingly, the second floor support 218b may be substantially similar to the floor support 218 as described herein. The second floor support 218b shown in FIG. 11 includes four of the standoffs 438 positioned on the lower surface 330 of the outboard panel 220 and extending from the outboard ribs 334a.

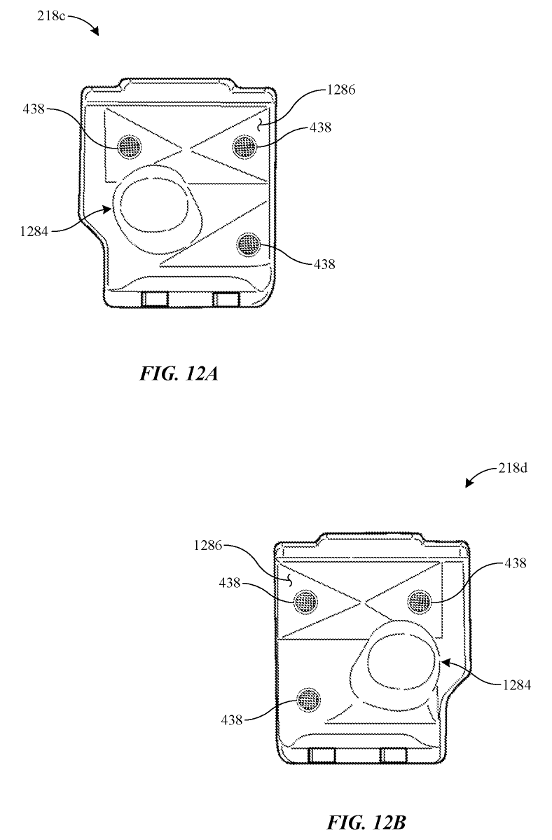

FIG. 12A is a bottom view illustration of the third floor support 218c that is configured to cover a portion of the front driver-side floor portion 109a, for example, beneath one of the seats 106 in the front driver-side sub-compartment 102a (see FIG. 1). The third floor support 218c may be substantially similar to the floor support 218 as described herein. In the implementation shown in FIG. 12A, the third floor support 218c comprises only a single panel and includes a first geometry 1284 and a second geometry 1286, each of which may correspond to (e.g., match) the portion of the front driver-side floor portion 109a. The third floor support 218c shown in FIG. 12A includes three of the standoffs 438, but may include any number of the standoffs 438.

FIG. 12B is a bottom view illustration of the fourth floor support 218d that is configured to cover a portion of the front passenger-side floor portion 109b, for example, beneath one of the seats 106 in the front passenger-side sub-compartment 102b (see FIG. 1). The fourth floor support 218d may be substantially similar to the floor support 218 as described herein. In the implementation shown in FIG. 12B, the fourth floor support 218d is a mirrored implementation of the third floor support 218c. Therefore, the fourth floor support 218d comprises a single panel and includes the first geometry 1284 and the second geometry 1286, each of which may correspond to (e.g., match) the portion of the front passenger-side floor portion 109b. The fourth floor support 218d shown in FIG. 12B includes three of the standoffs 438, but may include any number of the standoffs 438.

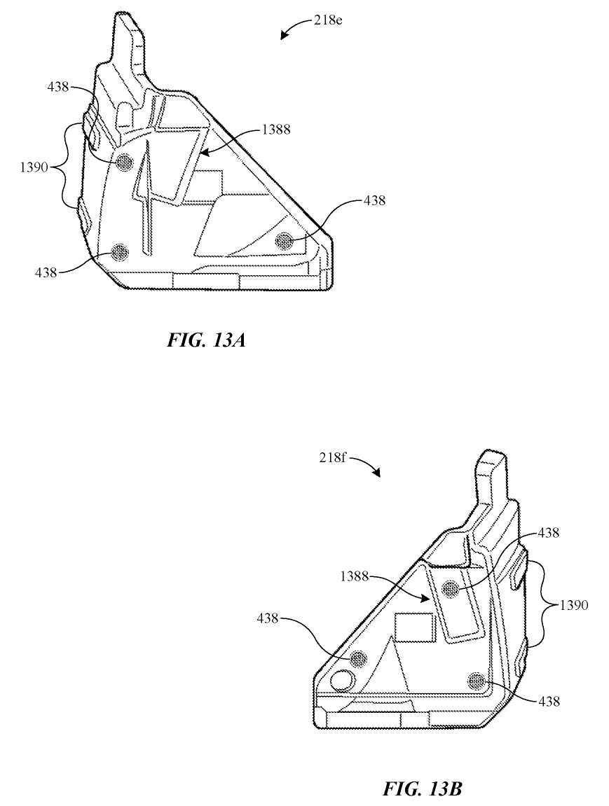

FIG. 13A is a bottom view illustration of the fifth floor support 218e that is configured to cover another portion of the front driver-side floor portion 109a, for example, beneath one of the seats 106 in the front driver-side sub-compartment 102a (see FIG. 1). The fifth floor support 218e may be substantially similar to the floor support 218 as described herein. In the implementation shown in FIG. 13A, the fifth floor support 218e comprises only a single panel and includes a third geometry 1388 and fourth geometries 1390, each of which may correspond to (e.g., match) the other portion of the front driver-side floor portion 109a. The fifth floor support 218e shown in FIG. 13A includes three of the standoffs 438, but may include any number of the standoffs 438.

FIG. 13B is a bottom view illustration of the sixth floor support 218f that is configured to cover another portion of the front passenger-side floor portion 109b, for example, beneath one of the seats 106 in the front passenger-side sub-compartment 102b (see FIG. 1). The sixth floor support 218f may be substantially similar to the floor support 218 as described herein. In the implementation shown in FIG. 13B, the sixth floor support 218f is a mirrored implementation of the fifth floor support 218e. Therefore, the sixth floor support 218f includes the third geometry 1388 and the fourth geometry 1390, each of which may correspond to (e.g., match) the other portion of the front passenger-side floor portion 109b. The sixth floor support 218f shown in FIG. 13B includes three of the standoffs 438, but may include any number of the standoffs 438.

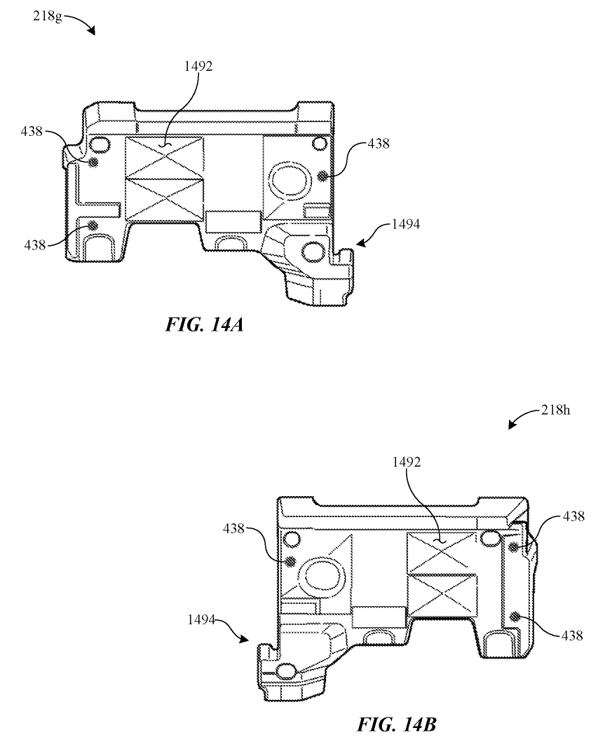

FIG. 14A is a bottom view illustration of the seventh floor support 218g that is configured to cover a portion of the rear driver-side floor portion 109c, for example, beneath one of the seats 106 in the rear driver-side sub-compartment 102c (see FIG. 1). The seventh floor support 218g may be substantially similar to the floor support 218 as described herein. In the implementation shown in FIG. 14A, the seventh floor support 218g comprises only a single panel and includes a fifth geometry 1492 and a sixth geometry 1494, each of which may correspond to (e.g., match) the portion of the rear driver-side floor portion 109c. The seventh floor support 218g shown in FIG. 14A includes three of the standoffs 438, but may include any number of the standoffs 438.

FIG. 14B is a bottom view illustration of the eighth floor support 218h that is configured to cover a portion of the rear passenger-side floor portion 109d, for example, beneath one of the seats 106 in the rear passenger-side sub-compartment 102d (see FIG. 1). The eighth floor support 218h may be substantially similar to the floor support 218 as described herein. In the implementation shown in FIG. 14B, the eighth floor support 218h is a mirrored implementation of the seventh floor support 218g. Therefore, the eighth floor support 218h includes the fifth geometry 1492 and the sixth geometry 1494, each of which may correspond to (e.g., match) the portion of the rear passenger-side floor portion 109d. The eighth floor support 218h shown in FIG. 14B includes three of the standoffs 438, but may include any number of the standoffs 438.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A floor support for a vehicle, comprising:
a panel configured to bear weight and to cover a portion of a floor structure of the vehicle, the panel including an upper surface and a lower surface opposite the upper surface; and
a standoff disposed on the lower surface of the panel, the standoff configured to space a portion of the lower surface of the panel from the portion of the floor structure, the standoff comprising:
legs extending away from the lower surface of the panel, wherein the legs are configured to bend to control movement of the panel relative to the portion of the floor structure in response to a force applied to the panel.

2. The floor support of claim 1, wherein the legs are configured to bend to control movement of the panel toward the portion of the floor structure in response to the force applied to the panel.

3. The floor support of claim 1, wherein the lower surface includes a geometric portion that substantially matches a geometry of the portion of the floor structure, and wherein the standoff is configured to space the geometric portion of the lower surface from the portion of the floor structure.

4. The floor support of claim 3, wherein the standoff is configured to space the geometric portion of the lower surface from the portion of the floor structure such that the geometric portion of the lower surface is free from contact with the portion of the floor structure.

5. The floor support of claim 4, wherein the standoff comprises multiple standoffs, and wherein the multiple standoffs are spaced along a peripheral region of the geometric portion of the lower surface of the panel.

6. The floor support of claim 1, wherein:
the legs extend away from the lower surface of the panel to define respective terminal ends of the legs;
the respective terminal ends of the legs are configured to contact the portion of the floor structure at respective contact locations; and
the legs are configured to pivot at the respective contact locations to bend in response to the force applied to the panel to control the movement of the panel relative to the portion of the floor structure.

7. The floor support of claim 6, wherein the legs of the standoff extend away from the lower surface of the panel in at least one of a downward direction or a longitudinal direction, and wherein the legs are configured to pivot at the respective contact locations in response to a component of the force applied to the panel in a lateral direction that is orthogonal to the downward direction.

8. The floor support of claim 6, wherein the legs are spaced from one another by a distance, and wherein the legs extend away from the lower surface of the panel to a leg thickness that is less than or equal to the distance.

9. The floor support of claim 1, wherein the standoff includes:
a base connected to the lower surface of the panel,
wherein the legs of the standoff are spaced from one another on the base and extend from the base of the standoff away from the lower surface of the panel.

10. The floor support of claim 9, wherein the base extends from the lower surface of the panel to a base thickness, and wherein the legs extend away from the base to a leg thickness that is greater than the base thickness.

11. The floor support of claim 10, wherein the standoff is formed unitarily with the lower surface of the panel.

12. A trim panel configured to cover a portion of a vehicle body inside a passenger compartment of a vehicle, the trim panel comprising:
an interior surface configured to face the passenger compartment of the vehicle;
an exterior surface opposite the interior surface and configured to face the portion of the vehicle body;
standoffs spaced along the exterior surface, each of the standoffs comprising:
discrete supports extending from the exterior surface and configured to contact the portion of the vehicle body, wherein the discrete supports are configured to deform to resist movement of the trim panel relative to the portion of the vehicle body.

13. The trim panel of claim 12, wherein the standoffs are spaced along the exterior surface of the trim panel to define a standoff region of the exterior surface, and wherein the standoff region of the exterior surface is configured to be free from contact with the portion of the vehicle body.

14. The trim panel of claim 12, wherein the discrete supports are configured to contact the portion of the vehicle body at respective contact locations, and wherein in response to a force applied to the trim panel:
the trim panel is configured to move relative to the portion of the vehicle body; and
the discrete supports are configured to remain in contact with the portion of the vehicle body at the respective contact locations.

15. The trim panel of claim 14, wherein the discrete supports of at least one of the standoffs extend from exterior surface to a leg thickness, and wherein an amount of the movement of the trim panel relative to the portion of the vehicle body is limited at least in part by the leg thickness of the discrete supports of the at least one of the standoffs.

16. A vehicle, comprising:
a portion of a vehicle body having a geometry; and
a panel covering the portion of the vehicle body, wherein at least a portion of the panel has a panel geometry that substantially matches the geometry of the portion of the vehicle body; and
standoffs spaced on a rear surface of the panel and defining a gap between the rear surface of the panel and the portion of the vehicle body, wherein the standoffs are configured to deform in response to a force applied to the panel to move the panel relative to the vehicle body while maintaining the gap defined by the one or more standoffs.

17. The vehicle of claim 16, wherein the portion of the vehicle body is located in a front driver-side sub-compartment of the vehicle.

18. The vehicle of claim 17, wherein the panel comprises:
a first panel configured to cover an outboard region of the portion of the vehicle body;
a second panel configured to cover an inboard region of the portion of the vehicle body; and
a bridge panel extending between the first panel and the second panel,
wherein the bridge panel extends over at least a portion of a drivetrain of the vehicle, and wherein the standoffs are disposed on the rear surface of at least one of the first panel or the second panel.

19. The vehicle of claim 16, wherein the panel is free from fastening means for inhibiting movement of the panel relative to the portion of the vehicle body.

20. The vehicle of claim 16, wherein the portion of the vehicle body comprises a first material, and wherein the standoffs comprise a second material that is different than the first material.
